(19) United States
(12) Patent Application Publication
(10) Pub. No.: US 2019/0067952 A1
(43) Pub. Date: Feb. 28, 2019

(54) BATTERY CHARGER WITH INTEGRATED DATA STORAGE

(71) Applicant: Michael C. Kirchoff, Happy Valley, OR (US)

(72) Inventor: Michael C. Kirchoff, Happy Valley, OR (US)

(21) Appl. No.: 15/685,913

(22) Filed: Aug. 24, 2017

(51) Int. Cl. H02J 7/00; A24F 47/00

(52) U.S. Cl. CPC H02J 7/007; G06Q 30/0251; A24F 47/008

(57) ABSTRACT

A storage-enabled battery charger may be configured to both store electronic data and charge a personal electronic device, such as an electronic cigarette. Methods of using the storage-enabled battery charger may include use as a promotional tool by a marketing entity, e.g., by distributing such chargers to recipients with promotional or other information already stored on the chargers.

### INTRODUCTION

Electronic cigarettes, also known as e-cigarettes, electronic nicotine delivery systems (ENDS), electronic non-nicotine delivery systems (ENNDS), or personal vaporizers (PVs) have become increasingly popular in recent years. Electronic cigarettes are handheld electronic devices that attempt to recreate the sensation of smoking a traditional tobacco cigarette. Such devices use a heating element to heat liquid (sometimes called an e-liquid or e-juice) to create an aerosol (also known as a vapor) which the user inhales. The aerosol often contains nicotine and may contain varying amounts of nicotine or other substances.

Electronic cigarettes are typically battery powered and may contain a variety of rechargeable battery types, such as a rechargeable lithium-ion battery. To use an electronic cigarette, a user must periodically recharge the battery using an electronic cigarette charger or similar device.

In recent years, users have also come to own a wide variety of other portable devices, for example personal electronic devices such as phones and music players and their chargers, portable data storage devices, etc., in addition to electronic cigarettes and electronic cigarette chargers. Such a variety of devices can be cumbersome to carry around, and the greater number of devices results in a higher likelihood of loss or misplacement.

### SUMMARY

The present disclosure describes an improved electronic cigarette charger having integrated data storage capabilities, as well as methods relating thereto.

In some embodiments, a battery charger may include: a first printed circuit board (PCB) including a battery charging circuit; a second PCB including a memory storage device; an input connector having an electrical power portion and a data communication portion, the electrical power portion electrically coupled to the first PCB and the second PCB, and the data communication portion coupled only to the second PCB; an output connector electrically connected to the battery charging circuit and configured to pass electrical power to a rechargeable device; and a same external housing enclosing the first PCB and the second PCB; wherein the input connector and the output connector are each fixed to the same external housing.

In some embodiments, a method for distributing information may include: storing information on a plurality of storage-enabled battery chargers configured to charge e-cigarettes; and distributing the plurality of storage-enabled battery chargers to a plurality of target users; wherein each of the storage-enabled battery chargers comprises an external housing at least partially enclosing a battery charging circuit coupled to a universal serial bus (USB) connector configured to receive power and data, a memory storage circuit coupled to the USB connector, and a battery-charging output connector coupled to the battery charging circuit.

Features, functions, and advantages may be achieved independently in various embodiments of the present disclosure, or may be combined in yet other embodiments, further details of which can be seen with reference to the following description and drawings.

### BRIEF DESCRIPTION OF THE DRAWINGS

FIG. 1 is a schematic diagram of an illustrative battery charger having integrated data storage.

FIG. 2 is a sectional side view of an embodiment of the device of FIG. 1.

FIG. 3 is a sectional top view of the embodiment of FIG. 2 taken along line 3-3.

FIG. 4 is another sectional top view of the embodiment of FIG. 2 taken along line 4-4.

FIG. 5 is a schematic circuit diagram of a USB standard A plug suitable for use with the present disclosure.

FIG. 6 is a schematic circuit diagram of a USB standard B plug suitable for use with the present disclosure.

FIG. 7 is a schematic circuit diagram of a micro USB plug suitable for use with the present disclosure.

FIG. 8 is a flowchart depicting steps of an illustrative method for using a battery charger having integrated data storages.

FIG. 9 is a flowchart depicting steps of an illustrative method of operation of a battery charger having integrated data storage.

FIG. 10 is a flowchart depicting steps of another illustrative method of operation of a battery charger having integrated data storage.

### DESCRIPTION

Various aspects and examples of devices having the ability to store electronic data and to charge a portable electronic device, as well as related methods, are described below and illustrated in the associated drawings. Unless otherwise specified, a battery charger having integrated data storage and/or its various components may, but are not required to, contain at least one of the structures, components, functionalities, and/or variations described, illustrated, and/or incorporated herein. Furthermore, unless specifically excluded, the process steps, structures, components, functionalities, and/or variations described, illustrated, and/or incorporated herein in connection with the present teachings may be included in other similar devices and methods, including being interchangeable between disclosed embodiments. The following description of various examples is merely illustrative in nature and is in no way intended to limit the disclosure, its application, or uses. Additionally, the advantages provided by the examples and embodiments described below are illustrative in nature and not all examples and embodiments provide the same advantages or the same degree of advantages.

### Definitions

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, unrecited elements or method steps.

Terms such as “first”, “second”, and “third” are used to distinguish or identify various members of a group, or the like, and are not intended to show serial or numerical limitation.

“Coupled” means connected, either permanently or releasably, whether directly or indirectly through intervening components, and is not necessarily limited to physical connection(s).

### Overview

In general, battery chargers having integrated data storage in accordance with aspects of the present disclosure may include an input connector (e.g., a USB connector configured to couple with a computing device and/or power source) and an output connector (e.g., configured to couple with an electronic cigarette or battery), as well as a charging circuit and a memory storage circuit housed in a single enclosure to form a unitary device having both charging and memory storage features. This integration enables a significantly improved user experience, and provides an exciting new channel for marketing, distribution, and consumption of portable information.

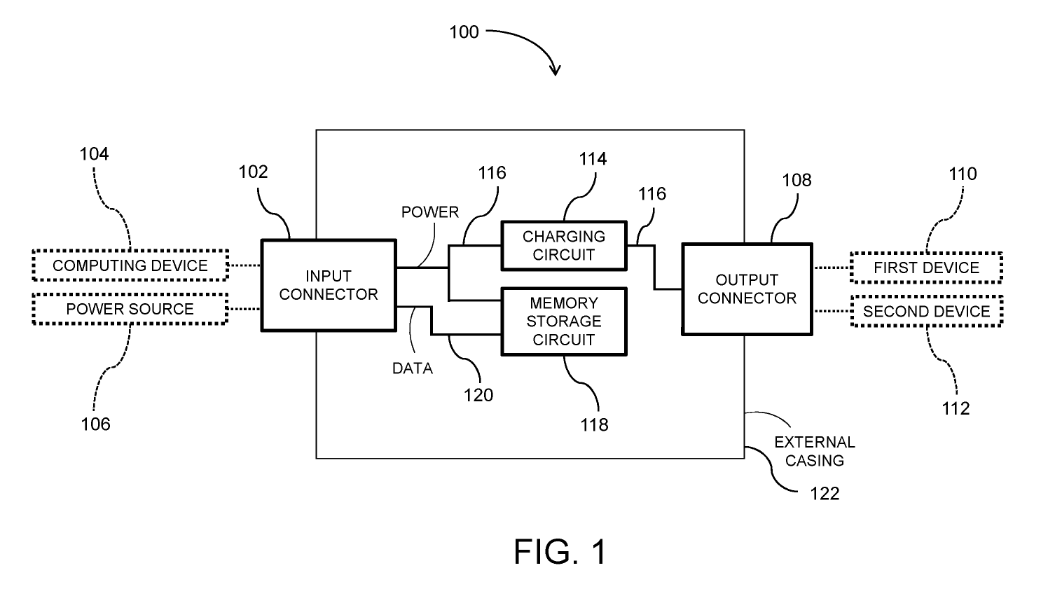

FIG. 1 is a schematic diagram of an illustrative battery charger 100 having integrated data storage. Charger 100 may be referred to interchangeably as a storage-enabled battery charger. An input connector 102, also referred to as a first connector, may include any suitable plug configured to couple charger 100 with a data processing system and power supply, such as a computing device 104 (e.g., a laptop or desktop PC), or with a non-data power source 106 (e.g., a wall adapter coupled to a standard electrical outlet). Accordingly, input connector 102 may include an electrical power portion and a data communication portion. In some examples, input connector 102 may include a Universal Serial Bus (USB) style plug having both data and electrical power capabilities.

An output connector 108 of charger 100 may include any suitable electrical connector configured to transfer charging power to a chargeable or rechargeable device coupled thereto. Output connector 108 may be configured to couple with at least one portable device, and may be a standard connector useful for recharging multiple kinds of devices. In some examples, output connector 108 may include a threaded plug such as those known in the art for charging electronic cigarettes.

With respect to the kinds of devices that may be chargeable by charger 100 via output connector 108, a first device 110 may include an electronic cigarette (e-cigarette or e-cig), electronic nicotine delivery system (ENDS), electronic non-nicotine delivery system (ENNDS), or personal vaporizer (PV). A second device 112 may include a backup battery, for example, for an electronic cigarette. While the present disclosure describes a battery charger having integrated data storage configured to charge an electronic cigarette, the charger may be configured to charge any suitable rechargeable device, e.g., portable electronic devices including cell phones, tablets, portable music players, and/or the like.

A charging circuit 114 couples the input to the output, and may include any suitable circuit or module configured to process a power signal 116 (e.g., 5V) from input connector 102 and make the processed signal available to output connector 108 for charging a secondary battery or other rechargeable device. Processing may include any suitable features, such as overload protection and thermal overload protection, as is known to those having skill in the art. Charging circuit 114 may comprise a printed circuit board (PCB) having one or more circuits configured to manage the electrical power to be supplied to a rechargeable battery or portable device.

A memory storage circuit 118 is in communication with input connector 102, and may include any suitable circuit or module configured to receive, store, transfer, and/or retrieve digital information, e.g., using the USB mass storage device class standard. Circuit 118 may comprise a printed circuit board (PCB) including one or more circuits and data storage components. Data may be communicated between circuit 118 and input connector 102 via data signal 120. Memory storage circuit 118 may include a solid state drive, flash memory, or the like having any suitable capacity. For example, the memory storage circuit may have a data storage capacity of 4 GB, 8 GB, 16 GB, 32 GB, or more. Memory storage circuit 118 and charging circuit 114 are contained within an external casing 122 (also referred to as a case, shell, or housing). Input connector 102 and output connector 108 are also coupled to the same casing, thereby forming a single unit.

### Examples, Components, and Alternatives

The following sections describe selected aspects of exemplary battery chargers having integrated data storage, as well as related systems and/or methods. The examples in these sections are intended for illustration and should not be interpreted as limiting the entire scope of the present disclosure. Each section may include one or more distinct embodiments or examples, and/or contextual or related information, function, and/or structure.

### A. Illustrative System

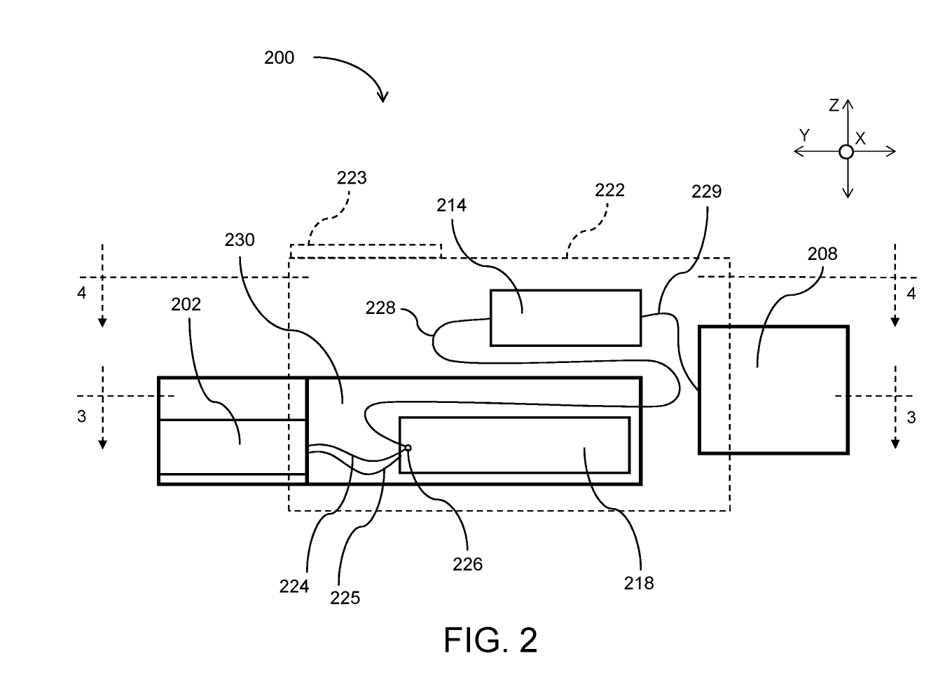

As shown in FIGS. 2-4, this section describes a battery charger having integrated data storage 200. Battery charger 200 is an example of battery charger 100, described above. Accordingly, similar components may be labeled with similar reference numbers.

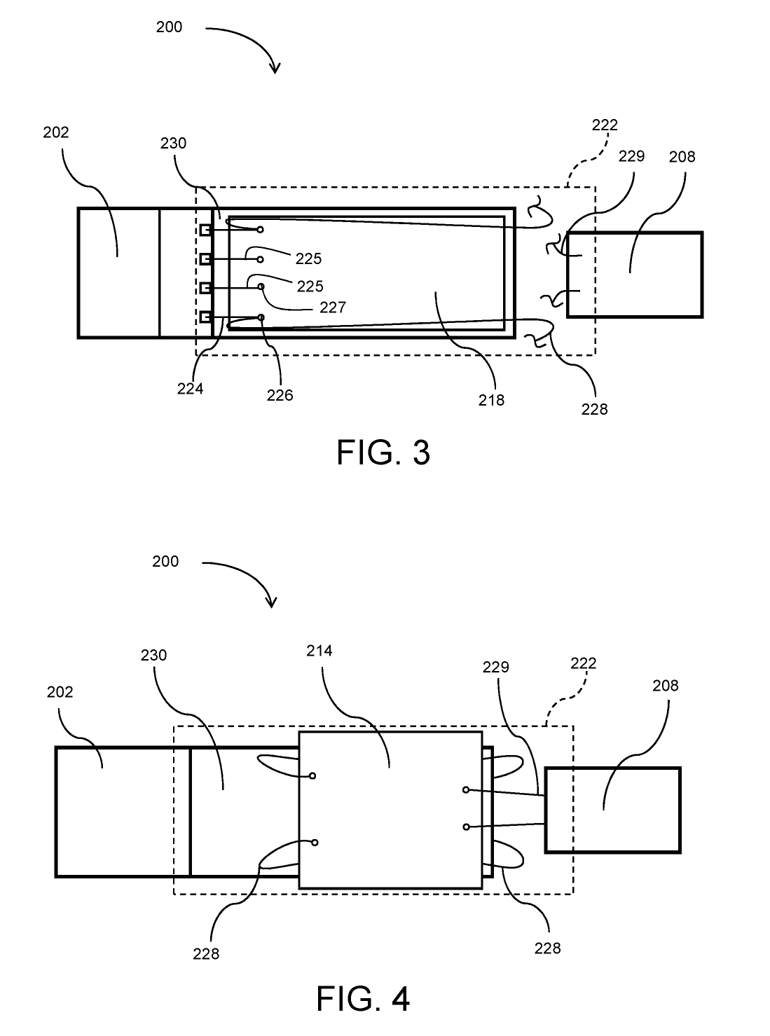

FIG. 2 is a schematic side view of the charger, showing illustrative connection and positioning relationships between various components. FIG. 3 is a first schematic sectional view of the charger, taken at line 3-3, and FIG. 4 is a second schematic sectional view of the charger, taken at line 4-4. Assuming the circuit boards of the memory module and the charging module define generally parallel X-Y planes, the sectional views are taken from a perspective along the Z axis. FIGS. 3 and 4 may therefore be considered top-down views.

Battery charger 200 includes an input connector 202, an output connector 208, a charging circuit 214, and a memory storage circuit 218, all substantially as described above. For example, memory storage circuit 218 is an example of memory storage circuit 118, and charging circuit 214 is an example of charging circuit 114. Charging circuit 214 and memory storage circuit 218 are contained within an external case 222. Input connector 202 and output connector 208 are coupled to external case 222, and, in this example, extend at least partially beyond the boundaries of the case. In some examples, input connector 202 and/or output connector 208 may be entirely within or entirely outside external case 222.

Input connector 202 is connected to memory storage circuit 218 by one or more first power conductors 224 and one or more data conductors 225. First power conductors 224 may include any suitable electrical connection between power leads on the input connector and the memory storage circuit configured to carry power from the input connector to the memory storage circuit. First power conductors 224 are coupled to memory storage circuit 218 at first electrical junctions 226. Data conductors 225 may include any suitable electronic connection between data leads of the input connector and the memory storage circuit configured to carry data to and from storage (e.g., a flash drive). Data conductors 225 are coupled to memory storage circuit 218 at respective second electrical junctions 227.

One or more second power conductors 228 connect first junctions 226 with charging circuit 214, thereby providing input electrical power to the charging circuit. In some examples, the charging circuit may be coupled directly to the power leads of the input connector, rather than the daisy-chain system illustrated in FIGS. 2-4. In this example, second power conductors 228 electrically connect charging circuit 214 to junctions 226 and thereby to input connector 202. Accordingly, the charging circuit and the memory storage circuit are wired in parallel to the power source. This method where the charging circuit is connected to the memory storage circuit (rather than directly to the power pins) allows more robust connection points to be utilized where two conductors (one wire 224 and one wire 228) must both be terminated. Junctions 226 may include any suitable electrical connection between the junction and the charging circuit and/or between the charging circuit and the output connector (e.g., soldered connection, plug and socket, etc.).

Additional third power conductors 229 couple charging circuit 214 to output connector 208, as shown, e.g., in FIG. 3. Conductors 224, 225, 228, and 229 may include flexible, insulated conductors (e.g., copper wires) that extend between connection points. In some examples, power conductors 224 and/or 228 may include direct connections between the pins of a USB plug and a circuit board and/or other forms of direct connection. Connecting conductors 224 and/or 228 may include any other suitable electrical connection between components configured to conduct or carry an electrical signal (e.g., power or data, as the case may be).

In addition to being held within shared external casing 222, memory storage circuit 218 is at least partially contained within an internal casing 230 (also referred to as a case, shell, or housing). Internal casing 230 may include any suitable protective structure configured to provide physical and/or electronic (e.g., noise) shielding and damage prevention for the memory storage circuit. In this example, internal casing 230 may include an open-ended box formed of metal walls. The printed circuit board (PCB) of circuit 218 may be held within the internal casing, e.g., in a friction fit and/or with one or more retaining prongs. The internal casing may be disposed entirely within external casing 222.

Charging circuit 214 is disposed external to memory circuit casing 230. In general, the plane of the PCB of circuit 214 may be described as generally parallel to the plane of the PCB of circuit 218.

Input connector 202 is positioned partially within memory circuit casing 230, and may be described as extending from the internal casing. Input connector 202 may be positioned only partially within memory circuit casing or may be positioned entirely outside memory circuit casing.

External casing 222 may include any suitable structure configured to provide some level of environmental protection (e.g., damage prevention) and housing for the internal components of charger 200, such that charger 200 may be considered an integrated unit. External casing may take any of a variety of suitable shapes, sizes, and/or designs configured to contain memory circuit casing 230 and charging circuit 214. External casing 222 may comprise any suitable material or materials, such as a hard plastic or a composite material.

External casing 222 may include a promotional shape and/or include selected markings (e.g., casing 222 may be printed with the logo of a company and/or manufacturer). In some examples, external casing 222 may take the shape of a sports ball (e.g., a football or basketball), a mascot, a company logo, a musical instrument, and/or any other suitable shape. In some examples, external casing 222 may include indicia 223, such as a logo, a website address, a slogan, a company name, a trademark, etc.

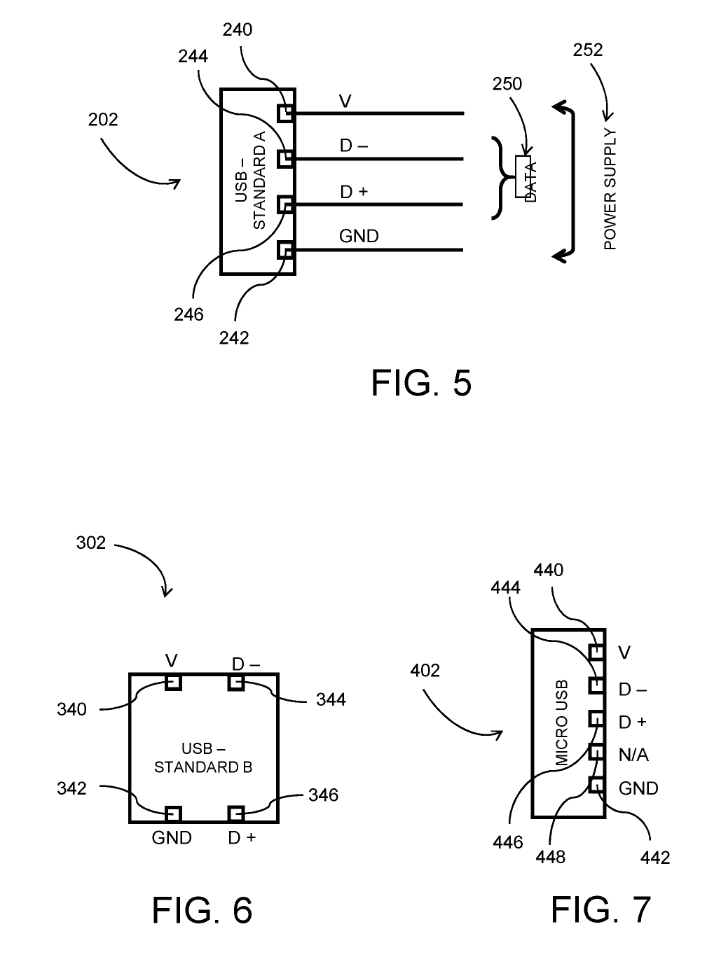

Input connector 202 may include any suitable plug or adapter configured to facilitate coupling circuit(s) of battery charger 200 with a computing device or other power supply and/or data source. In this example, input connector 202 includes a USB Standard A style male plug. In some examples, input connector 202 may include a USB Standard B style male plug, a micro USB style male plug, or any other suitable plug. FIGS. 5-7 illustrate some suitable examples of input connectors 102 and 202.

As shown in FIG. 5, input connector 202 includes a USB standard A style male plug which includes four pins. Specifically, a first pin 240 is the high voltage input and a second pin 242 is the ground or low voltage input. Together pin 240 and pin 242 provide a power supply 252 for the device. A third pin 244 and a fourth pin 246 provide the negative and positive portions, respectively, for communicating a data signal 250.

As shown in FIG. 6, other examples of input connector 102 may include a USB Standard B male style plug, referred to in this example as input connector 302. Input connector 302 has a first pin 340 and a second pin 342 which provide the high voltage and ground portions, respectively, of a power supply. A third pin 344 and a fourth pin 346 provide the terminals for communicating a data signal.

As shown in FIG. 7, other examples of input connector 102 may include a micro USB male style plug, referred to in this example as an input connector 402. Input connector 402 has a first pin 440 and a second pin 442 which provide the high voltage and ground portions, respectively, of a power supply. A third pin 444 and a fourth pin 446 provide the terminals for communicating a data signal. Micro USB input connector 402 also has a fifth pin 448 which is not relevant to either the data or the power supply. Pin 448 serves to determine whether the connector is a micro-A or micro-B USB, either of which may be suitable for input plug 102 depending on the embodiment of battery charger 100.

Output connector 208 may include any suitable charging interface configured to provide an electrical connection for recharging a battery, e.g., for portable electronic devices such as first device 110 and/or second device 112. In battery charger 200, output connector 208 includes a cylindrical, threaded connector that is typically used for charging electronic cigarettes.

### B. Illustrative Methods of Use

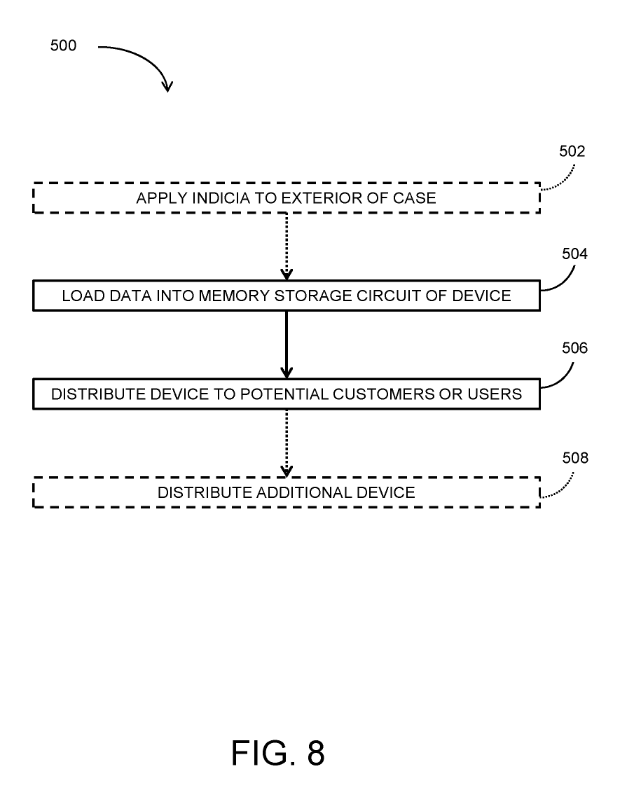

This section describes illustrative methods for using a battery charger having integrated data storage; see FIGS. 8-10. Aspects of systems described above may be utilized in the method steps described below. Where appropriate, reference may be made to components and systems that may be used in carrying out each step. These references are for illustration, and are not intended to limit the possible ways of carrying out any particular step of the method.

FIG. 8 is a flowchart depicting steps performed in an illustrative method 500 for use by a specific type of user, and may not recite the complete process or all steps of the method. Although various steps of method 500 are described below and depicted in FIG. 8, the steps need not necessarily all be performed, and in some cases may be performed simultaneously or in a different order than the order shown.

Method 500 may be performed by any company, organization, individual, or marketing entity (referred to herein as a “distributor”) using battery chargers having integrated data storage as a marketing and/or promotional tool and/or in such a way as to distribute information about themselves or a related entity.

At an optional step 502 of method 500, the distributor may cause indicia to be applied (e.g., printed, engraved, adhered, etc.) onto the exterior surface of external casing 122. Indicia may include any suitable text, image, pattern, likeness, logo, or other identifying marks. In some examples, the battery charger may have an external casing that itself includes a promotional shape. In some examples, step 502 may be excluded or performed by a different party.

At step 504 of method 500, the distributor causes selected data (e.g., promotional, informational, and/or reference materials) to be loaded onto a memory storage portion of the battery charger (e.g., charger 100 or 200), such as memory storage circuit 118. In some examples, promotional materials may include product information, e.g., a catalog or product listing, promotional and other video(s), sample song(s) or other audio files, advertising materials, and/or other marketing information.

At a step 506, the distributor distributes the battery chargers having integrated data storage containing promotional materials to potential customers and/or users. For example, the distributor may hand out chargers at a conference or show, provide them for sale or for free to customers, include them with another purchase, use them as a promotional item in a marketing campaign, exchange the chargers for user information (e.g., email addresses for follow-up marketing opportunities), and/or the like. For example, a manufacturer of e-liquids or e-liquid containers may distribute e-cigarette chargers with their catalog of flavors and ordering information saved on the charger. In another example, a music artist or distributor may provide chargers (for free or for a price) that include sample song and/or video files saved thereon. In another example, a sports team may provide chargers having the team's schedule saved on the memory module of the charger, and in some cases may cause the external casing of the charger to be shaped according to some aspect of the sport in question (e.g., like a baseball). Any number of such applications are made possible and/or facilitated by the present disclosure.

At an optional step 508 of method 500, the distributor may distribute a backup battery or other device along with the storage-enabled battery charger. In some examples, the backup battery or other device may have a promotional shape or the exterior may be printed with indicia, similar to the shape and indicia considerations described above. In some examples, step 508 may be excluded or performed by a different party.

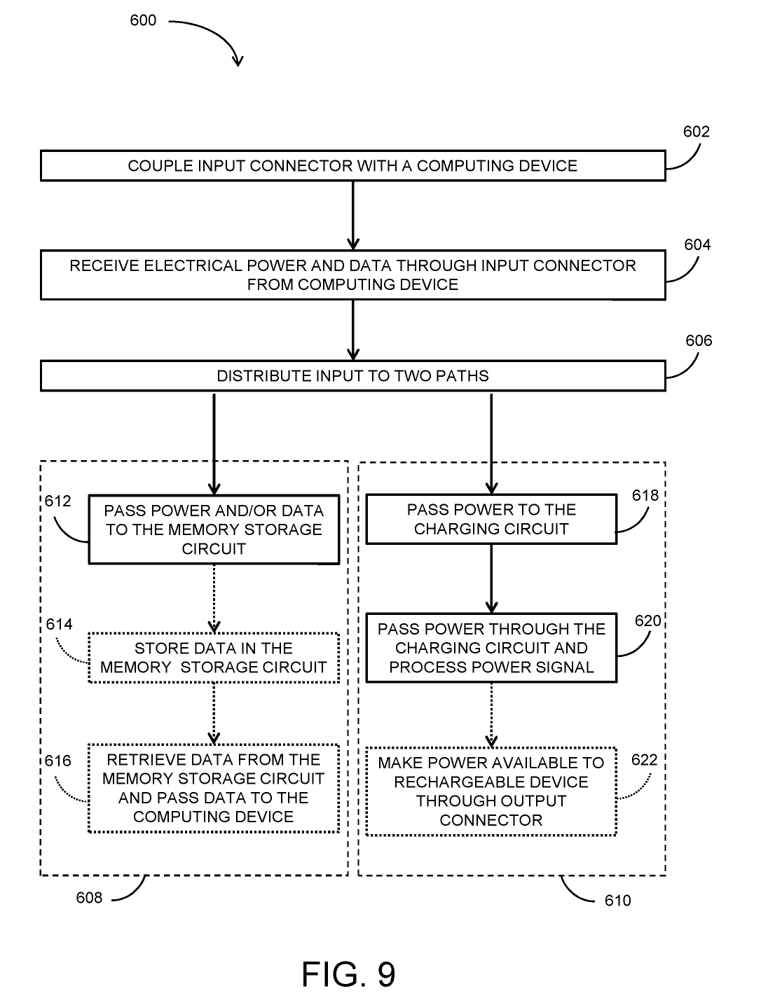

Turning to FIG. 9, a flowchart is provided illustrating steps performed in a method 600. Method 600 is an illustrative method for using a storage-enabled battery charger as a charger and/or data storage device, and may not recite the complete process or all steps of the method. Although various steps of method 600 are described below and depicted in FIG. 9, the steps need not necessarily all be performed, and in some examples, may be performed simultaneously or in a different order than the order shown.

Method 600 is a method of operation for a battery charger having integrated data storage. Some steps may occur automatically as consequences of other steps. Some steps may be initiated by an end user. In some examples, the end user may have received the storage-enabled battery charger from a distributor (e.g., see method 500).

At step 602, an input connector of the battery charger couples with a computing device (e.g., by plugging a USB connector into a USB port of a desktop computer). At step 604, the battery charger receives electrical power and data through the input connector from the computing device. At step 606, the storage-enabled battery charger distributes the electrical power and/or data to two parallel paths 608, 610.

In step 612 of path 608, electrical power and data are passed from the input connector to a memory storage circuit of the charger. In an optional step 614, the data is stored in the memory storage circuit. In an optional step 616, stored data is retrieved from the memory storage circuit and passed to the computing device.

If the end user is using the storage-enabled battery charger only as a charger, then steps 614 and 616 are unnecessary and may not be performed. In other words, if there is no data to be stored and/or retrieved, then power may be passed to memory storage circuit 118 without any data being stored or retrieved. Additionally or alternatively, only one of steps 614 or 616 may be performed. If the end user is using the battery charger only to store data, then step 614 may be performed and step 616 may not be performed. If the end user is using the battery charger only to retrieve data, then step 616 may be performed and step 614 may not be performed.

On path 610, electrical power (only) is passed from the input connector to a charging circuit of the device, in step 618. In step 620, the charging circuit processes the electrical power signal as needed and passes the electrical power signal to an output connector. In an optional step 622, the battery charger makes the electrical power available to a rechargeable device through the output connector.

If the end user is using the storage-enabled battery charger only as a data storage device, then step 622 is unnecessary and may not be performed. In other words, electrical power may be passed to and processed by the charging circuit, but if no device has been coupled to the output connector then the electrical power will not be passed through the output connector.

In some examples, paths 608 and 610 may be performed simultaneously. For example, the end user may charge an e-cigarette battery while saving or accessing data stored on the memory storage circuit. For example, a user may plug the storage-enabled charger into a personal computer, and review a catalog of e-liquids stored on the charger while also charging his or her e-cigarette with the same charger.

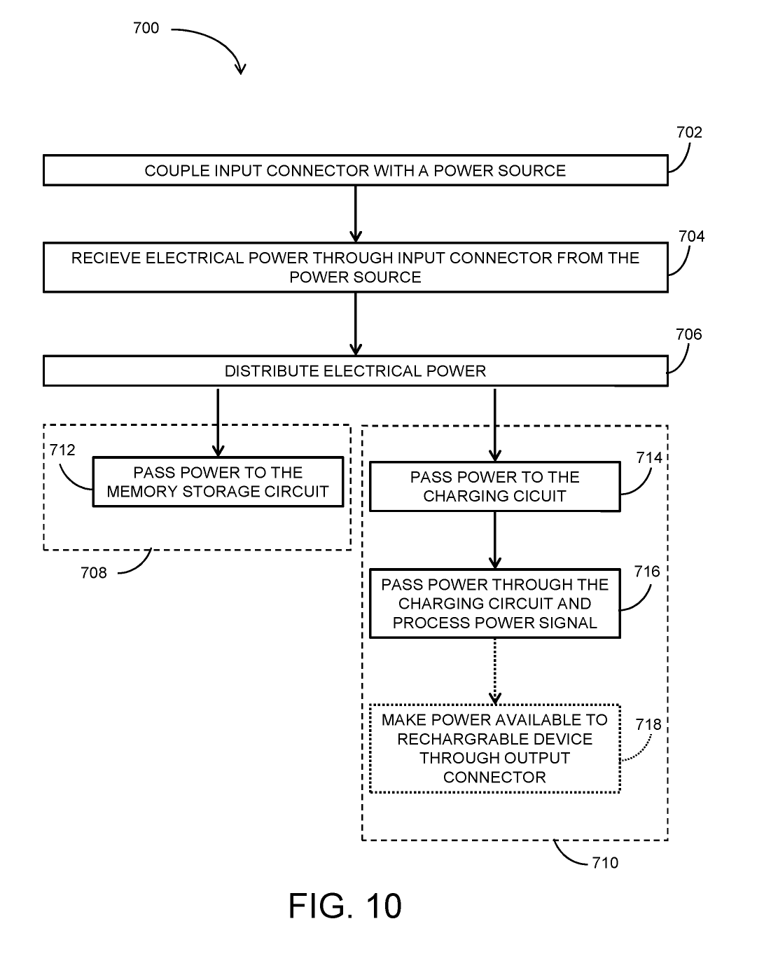

FIG. 10 is a flowchart illustrating steps performed in an illustrative method 700 for using a storage-enabled battery charger as a charging device, and may not recite the complete process or all steps of the method. Although various steps of method 700 are described below and depicted in FIG. 10, the steps need not necessarily all be performed, and in some cases may be performed simultaneously or in a different order than the order shown.

At step 702, an input connector (e.g., connector 102) of the battery charger is coupled with a power source (e.g., power source 106). At step 704, the battery charger receives electrical power through the input connector from the power source. At step 706, the battery charger distributes the electrical power to two paths 708 and 710.

On path 708, battery charger having integrated data storage 100 passes electrical power from the input connector to a memory storage circuit of the charger (e.g., circuit 118), in a step 712. The power source in this example provides electrical power but no data to be stored and/or retrieved. As such, power is passed to the memory storage circuit without any data being stored or retrieved.

On path 710, the battery charger passes electrical power from the input connector to a charging circuit (e.g., circuit 114), in step 714. Step 714 may include step 712, such that power is passed through the memory storage circuit to the charging circuit (see description of charger 200). In step 716, the battery charger processes the electrical power signal as needed and passes the electrical power signal to an output connector (e.g., connector 108). In an optional step 718, the battery charger makes the electrical power available to a rechargeable device through the output connector.

### C. Additional Examples and Illustrative Combinations

This section describes additional aspects and features of a battery charger having integrated data storage, as well as related methods, presented without limitation as a series of paragraphs, some or all of which may be alphanumerically designated for clarity and efficiency. Each of these paragraphs can be combined with one or more other paragraphs, and/or with disclosure from elsewhere in this application, in any suitable manner. Some of the paragraphs below expressly refer to and further limit other paragraphs, providing without limitation examples of some of the suitable combinations.

A0. A device for charging an electronic cigarette comprising an input connector, an output connector, a charging circuit configured to process power from the input connector and make the power available to the output connector, and a memory storage circuit configured to send and receive data through the input connector.

A1. The device of paragraph A0 further comprising an external casing wherein the charging circuit and the memory storage circuit are disposed within the external casing and the input connector and the output connector are disposed partially within the external casing

A2. The device of paragraph A1 wherein the external casing has a shape that serves a promotional purpose.

A3. The device of paragraph A1 further comprising a memory storage circuit housing wherein the memory storage circuit is disposed within the memory storage circuit housing and the memory storage circuit casing is internal with respect to the external casing.

A4. The device of paragraph A0 wherein the input connector is a USB standard A male plug.

A5. The device of paragraph A0 wherein the input connector is a USB standard B male plug.

A6. The device of paragraph A0 wherein the input connector is a micro USB male plug.

B0. A portable electronic data storage device comprising an input connector, an output connector, a memory storage circuit configured to receive, store, and receive data, and a charging circuit configured to process power from the input connector and make the power available to the output connector.

B1. The device of paragraph B0 further comprising an external casing wherein the charging circuit and the memory storage circuit are disposed within the external casing and the input connector and the output connector are disposed partially within and partially outside the external casing

B2. The device of paragraph B1 wherein the external casing has a shape that serves a promotional purpose.

B3. The device of paragraph B1 further comprising a memory storage circuit casing wherein the memory storage circuit is disposed within the memory storage circuit casing and the memory storage circuit casing is disposed at least partially within the external casing.

B3. The device of paragraph B0 wherein the input connector is a USB standard A male plug.

B4. The device of paragraph B0 wherein the input connector is a USB standard B male plug.

B5. The device of paragraph B0 wherein the input connector is a micro USB male plug.

C0. A method of using a combination charger and memory storage device comprising: applying indicia to an exterior case of the combination charger and memory storage device; loading promotional materials, catalogs, or other relevant information onto a memory storage portion of the combination charger and memory storage device; and distributing the combination charger and memory storage device to end users.

C1. The method of paragraph C0 further comprising distributing backup batteries for a personal electronic device in addition to the combination charger and memory storage device.

D0. A battery charger comprising:

a first printed circuit board (PCB) including a battery charging circuit;

a second PCB including a memory storage device;

an input connector having an electrical power portion and a data communication portion, the electrical power portion electrically coupled to the first PCB and the second PCB, and the data communication portion coupled only to the second PCB;

an output connector electrically connected to the battery charging circuit and configured to pass electrical power to a rechargeable device; and

a same external housing enclosing the first PCB and the second PCB;

wherein the input connector and the output connector are each fixed to the same external housing.

D1. The battery charger of D0, wherein the external housing comprises a rigid plastic.

D2. The battery charger of D0, wherein the input connector comprises a universal serial bus (USB) connector.

D3. The battery charger of D2, wherein the USB connector is type A.

D4. The battery charger of D0, wherein the first PCB and the second PCB are coupled to the electrical power portion of the input connector in parallel.

D5. The battery charger of D4, wherein the first PCB receives power through one or more electrical junctions disposed on the second PCB.

D6. The battery charger of D0, wherein the first PCB and the second PCB are generally parallel to each other.

D7. The battery charger of D0, further comprising an internal housing disposed within the external housing, wherein the second PCB is housed by the internal housing.

D8. The battery charger of D7, wherein the internal housing is configured to protect the memory storage device from damage by one or more environmental factors.

D9. The battery charger of D8, wherein the one or more environmental factors comprise electronic noise.

D10. The battery charger of D0, wherein the memory storage circuit comprises a flash memory device.

E0. A method for distributing information, the method comprising:

storing information on a plurality of storage-enabled battery chargers configured to charge e-cigarettes; and

distributing the plurality of storage-enabled battery chargers to a plurality of target users;

wherein each of the storage-enabled battery chargers comprises an external housing at least partially enclosing a battery charging circuit coupled to a universal serial bus (USB) connector configured to receive power and data, a memory storage circuit coupled to the USB connector, and a battery-charging output connector coupled to the battery charging circuit.

E1. The method of E0, wherein storing the information includes storing one or more audio files.

E2. The method of E0, wherein storing the information includes storing one or more video files.

E3. The method of E0, wherein storing the information includes storing marketing information targeting the plurality of target users.

E4. The method of E0, wherein storing the information includes storing product information.

E5. The method of E4, wherein the product information comprises a catalog.

E6. The method of E4, wherein the product information comprises a user manual.

E7. The method of E0, further comprising:

applying indicia to the external housing of each of the storage-enabled battery chargers.

E8. The method of E7, wherein the indicia comprises a logo.

E9. The method of E0, wherein the external housing is configured to have an appearance corresponding to the information stored in the memory storage circuit.

E10. The method of E0, wherein the memory storage circuit comprises a flash memory device.

E11. The method of E0, further comprising:

for one of the storage-enabled battery chargers, displaying at least a portion of the stored information on a display of a computing device to which the storage-enabled battery charger is connected.

E12. The method of E11, further comprising:

simultaneously with the displaying step, charging an e-cigarette device using the storage-enabled battery charger.

### Advantages, Features, Benefits

The different embodiments and examples relating to battery chargers having integrated data storage described herein provide several advantages over known solutions.

For example, illustrative embodiments and examples described herein allow an end user to decrease the number of devices required to be carried. This decreases the likelihood that the end user will lose a charger as it is integrated with the portable data storage device.

Additionally, and among other benefits, illustrative embodiments and examples described herein allow an end user to more easily multitask, because an end user can couple a single device to their computer and complete tasks related to both device charging and data review.

Additionally, and among other benefits, illustrative embodiments and examples described herein enable new marketing, promotion, and distribution methods for companies and individuals. Detailed or extensive information can be communicated to the recipient, such as a catalog, promotional video, and/or songs, videos, and the like, all in a small device desirable to and functional for the recipient. This is especially true for target recipients who also use e-cigarettes and the like.

Additionally, and among other benefits, illustrative embodiments and examples described herein allow a company to deliver substantive marketing information such as a catalog, a promotional video or videos, and/or sample songs, videos, and/or materials in a format that is highly portable and reusable. Thus, a recipient is likely to carry the information with them and the information is less likely to be lost or thrown away because it is easy to carry and contained in a device that is valuable and/or useful to the recipient. Contributing to the valuable nature of the device is the capacity for reuse, as memory storage portion may be both read- and write-enabled.

Additionally, and among other benefits, illustrative embodiments and examples described herein allow a company to deliver substantive marketing info such as that described above in a format that the customer is more likely to view while at home on a computer and waiting for their device to charge. Accordingly, the recipient is more likely to be at home, at leisure, and inclined to make a purchase.

Additionally, and among other benefits, illustrative embodiments and examples described herein allow a company to deliver substantive marketing info such as that described above in a format that comes with a valuable and/or useful device that can be adapted to the potential customer's own use, thus potentially creating positive associations with the company.

Additionally, and among other benefits, illustrative embodiments and examples described herein allow a company to deliver substantive marketing info such as that described above in a format that saves the cost of printing, storage, and/or transportation associated with similar quantities of information in print form.

No known system or device can perform these functions, particularly wherein the device functions as a battery charger (e.g., for an electronic cigarette). Thus, the illustrative embodiments and examples described herein are particularly useful for companies wishing to reach a target audience interested in using electronic cigarettes or for recipients and end users who use electronic cigarettes. However, not all embodiments and examples described herein provide the same advantages or the same degree of advantage.

### Conclusion

The disclosure set forth above may encompass multiple distinct examples with independent utility. Although each of these has been disclosed in its preferred form(s), the specific embodiments thereof as disclosed and illustrated herein are not to be considered in a limiting sense, because numerous variations are possible. To the extent that section headings are used within this disclosure, such headings are for organizational purposes only. The subject matter of the disclosure includes all novel and nonobvious combinations and subcombinations of the various elements, features, functions, and/or properties disclosed herein. The following claims particularly point out certain combinations and subcombinations regarded as novel and nonobvious. Other combinations and subcombinations of features, functions, elements, and/or properties may be claimed in applications claiming priority from this or a related application. Such claims, whether broader, narrower, equal, or different in scope to the original claims, also are regarded as included within the subject matter of the present disclosure.

1. A battery charger comprising:
a first printed circuit board (PCB) including a battery charging circuit;
a second PCB including a memory storage circuit;
an input connector having an electrical power portion and a data communication portion, the electrical power portion electrically coupled to provide operating power in parallel to the first PCB and the second PCB, and the data communication portion coupled only to the second PCB;
an output connector electrically connected to the battery charging circuit and configured to pass electrical power to a rechargeable device; and
a same external housing enclosing the first PCB and the second PCB;
wherein the input connector and the output connector are each fixed to the same external housing.

2. The battery charger of claim 1, wherein the external housing comprises a rigid plastic.

3. The battery charger of claim 1, wherein the input connector comprises a universal serial bus (USB) connector.

4. The battery charger of claim 3, wherein the USB connector is type A.

5. (canceled)

6. The battery charger of claim 1, wherein the first PCB receives power through one or more electrical junctions disposed on the second PCB.

7. The battery charger of claim 1, wherein the first PCB and the second PCB have a generally parallel orientation relative to each other.

8. The battery charger of claim 1, wherein the memory storage circuit comprises a flash memory device.

9. A method for distributing information, the method comprising:
storing information on a plurality of storage-enabled battery chargers configured to charge electronic cigarettes; and
distributing the plurality of storage-enabled battery chargers to a plurality of target users;
wherein each of the storage-enabled battery chargers comprises an external housing at least partially enclosing a battery charging circuit coupled to a universal serial bus (USB) connector configured to receive power and data, a memory storage circuit coupled to the USB connector, and a battery-charging output connector coupled to the battery charging circuit; and
wherein the USB connector of each of the storage-enabled battery chargers is configured to provide electrical power in parallel to the battery charging circuit and the memory storage circuit.

10. The method of claim 9, wherein storing the information includes storing one or more audio files.

11. The method of claim 9, wherein storing the information includes storing product information.

12. The method of claim 11, wherein the product information comprises a catalog.

13. The method of claim 11, wherein the product information comprises a user manual.

14. The method of claim 9, further comprising:
applying indicia to the external housing of each of the storage-enabled battery chargers.

15. The method of claim 14, wherein the indicia comprises a logo.

16. The method of claim 9, wherein the external housing is configured to have an appearance corresponding to the information stored in the memory storage circuit.

17. The method of claim 9, wherein the memory storage circuit comprises a flash memory device.

18. The method of claim 9, further comprising:
for one of the storage-enabled battery chargers, displaying at least a portion of the stored information on a display of a computing device to which the storage-enabled battery charger is connected.

19. The method of claim 18, further comprising:
simultaneously with displaying the at least a portion of the stored information on the display, charging an electronic cigarette device using the storage-enabled battery charger.

20. The battery charger of claim 1, wherein the rechargeable device comprises an electronic cigarette.
